(19) United States
(12) Patent Application Publication
(10) Pub. No.: US 2024/0129129 A1
(43) Pub. Date: Apr. 18, 2024

(54) SYSTEMS, METHODS, AND STORAGE MEDIA FOR VALIDATING CRYPTOGRAPHICALLY SIGNED INFORMATION

(71) Applicant: Bloom Protocol, LLC, Bronx, NY (US)

(72) Inventor: Dustin van Schouwen, Portsmouth, NH (US)

(73) Assignee: Bloom Protocol, LLC, Bronx, NY (US)

(21) Appl. No.: 18/046,141

(22) Filed: Oct. 12, 2022

(51) Int. Cl. H04L 9/32; G06N 7/00

(52) U.S. Cl. CPC H04L 9/3247; G06N 7/005

(57) ABSTRACT

Systems, methods, and storage media for validating cryptographically signed information are disclosed. Exemplary implementations may: allow a first user to create a least one requirement defining the format of at least one data element tied to a second user; allow the second user to submit the at least one data element, the at least one data element being cryptographically signed by a third user, wherein the third user is trusted by the first user; validate that the at least one data element meets the at least one requirement and is cryptographically signed by the third user; and make at least one first information request to at least one remote platform as a result of the validation of the at least one data element.

### FIELD OF THE DISCLOSURE

The present disclosure relates to systems, methods, and storage media for validating cryptographically signed information.

### BACKGROUND

Information Validation technology offers methods to validate that information was “signed” in some way by a party in ownership of a specific cryptographic private key, which can be leveraged for purposes such as verification of information, authorization, authentication, and any other act which may involve verifying a statement claim from an individual.

However, current validation technologies are limited in scope and are engineered to handle pre-determined sets of verified data elements. Such current systems are not scalable nor flexible enough to handle growing, complex vetted information submitted by outside parties. There is no unified system that allows for multiple types of data with various requirements. Furthermore, many of these systems lack the necessary mechanisms that would allow an outside party to hand over such information securely and privately.

This background information is provided to reveal information believed by the applicant to be of possible relevance to the present invention. No admission is necessarily intended, nor should be construed, that any of the preceding information constitutes prior art against the present invention.

### SUMMARY

One aspect of the present disclosure relates to a system configured for validating cryptographically signed information. The system may include one or more hardware processors configured by machine-readable instructions. The processor(s) may be configured to allow a first user to create at least one requirement defining the format of at least one data element tied to a second user. The processor(s) may also be configured to allow the second user to submit the at least one data element, the at least one data element being cryptographically signed by a third user, wherein the third user is trusted by the first user. The processor(s) may also be configured to validate that the at least one data element meets the at least one requirement and is cryptographically signed by the third user. The processor(s) may also be configured to make at least one first information request to at least one remote platform as a result of the validation of the at least one data element.

In some implementations of the system, the processor(s) may be configured to allow the first user to create at least one second requirement further defining the format of the at least one data element tied to the second user. The processor(s) may also be configured to validate that the at least one data element meets the at least one second requirement and is cryptographically signed by the third user. The processor(s) may also be configured to make at least one second information request to the at least one remote platform as a result of the validation of the at least one data element meeting the at least one second requirement

In some implementations of the system, the processor(s) may be configured to output at least one second data element to the second user, the at least one data element being cryptographically signed by the first user.

In some implementations of the system, the processor(s) may be configured to allow the first user to create a least one third requirement defining the format of the at least one second data element tied to the second user. The processor(s) may also be configured to allow the second user to submit the at least one second data element, the at least one data element being cryptographically signed by the second user. The processor(s) may also be configured to validate that the at least one second data element meets the at least one third requirement and is cryptographically signed by the second user. The processor(s) may also be configured to make at least one third information request to at least one remote platform as a result of the validation of the at least one second data element.

In some implementations of the system, the first information request and the second information request occur sequentially.

In some implementations of the system, the first information request and the second information request may be further defined as a directed acyclic graph.

In some implementations of the system, each step is conditionally dependent on at least one prior step.

In some implementations of the system, upon a request of the first user, the first information request is made without the validation that the at least one data element meets the at least one requirement.

Another aspect of the present disclosure relates to a method for validating cryptographically signed information. The method may include a first user creating at least one requirement defining the format of at least one data element tied to a second user. The method may also include the second user submitting the at least one data element, the at least one data element being cryptographically signed by a third user, wherein the third user is trusted by the first user. The method may also include validating that the at least one data element meets the at least one requirement and is cryptographically signed by the third user. The method may also include making at least one first information request to at least one remote platform as a result of the validation of the at least one data element.

Yet another aspect of the present disclosure relates to a non-transient computer-readable storage medium having instructions embodied thereon, the instructions being executable by one or more processors to perform a method for validating cryptographically signed information. The method may include a first user creating at least one requirement defining the format of at least one data element tied to a second user. The method may also include the second user submitting the at least one data element, the at least one data element being cryptographically signed by a third user, wherein the third user is trusted by the first user. The method may also include validating that the at least one data element meets the at least one requirement and is cryptographically signed by the third user. The method may also include making at least one first information request to at least one remote platform as a result of the validation of the at least one data element.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 illustrates a system 100 configured for validating cryptographically signed information, in accordance with one or more implementations.

FIG. 2 illustrates an exemplary diagram of a decentralized ledger network 200 found within the system 100, in accordance with one or more implementations.

FIGS. 3A, 3B, 3C, and/or 3D illustrate method(s) 300 for validating cryptographically signed information, in accordance with one or more implementations.

### DETAILED DESCRIPTION

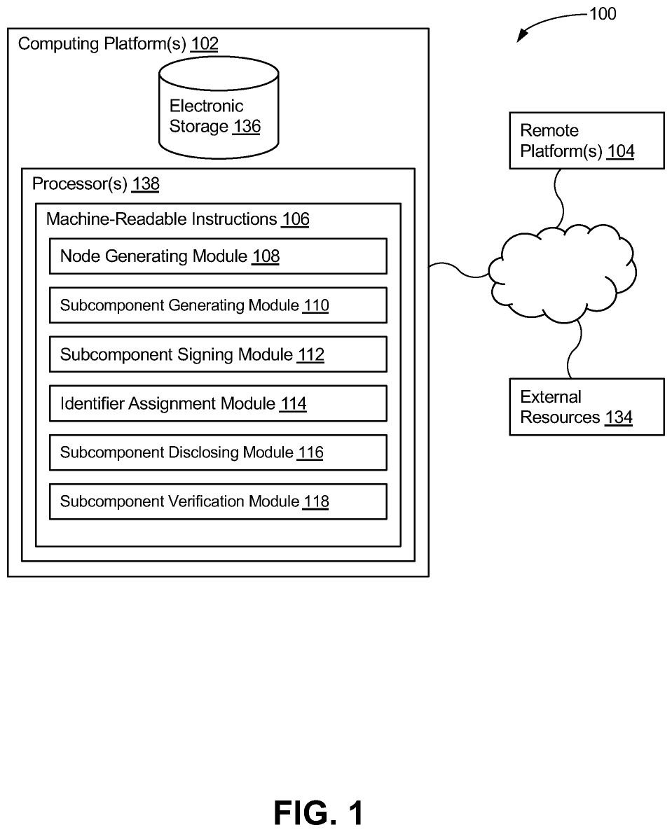

FIG. 1 illustrates a system 100 configured for validating cryptographically signed information, in accordance with one or more implementations. The system 100 allows businesses or similar users (herein “Business(es)”) to allow End-user(s) to generate reusable data elements about themselves, generally in the form of Verifiable Credentials (VCs) as defined by the W3C Verifiable Claim standard, which can be leveraged to interact with smart contracts on blockchains, or various other remote platform(s) containing verified data about an end-user, for various forms of decisioning or validation tied to the End-user(s).

Business(es) are granted permissions to create and manage their own records within the system 100 corresponding to sets of Verifiable Credentials they wish to accept, and methods to analyze sets of Verifiable Credentials provided by End-User(s) to analyze them for criteria corresponding to their proprietary decisioning processes

End-User(s) represent any person or organization that the Business wishes to verify information about in some way. The End-User(s) are responsible for providing Verifiable Credentials to the Business's instance of the system 100.

For the sake of an example of how the system 100 may be leveraged in an interoperable manner, we may give the example of the W3C Verifiable Claim standard as to how these individual data elements could be packaged, but any cryptographic signature method with sufficiently non-ambiguous markup denoting the format of the information requested and the format requirements for the data elements would be sufficient to establish the intent of the signed data structure.

As stated within the W3C Verifiable Claim standard (found at www.w3.org/TR/vc-data-model/#what-is-a-verifiable-credential), a physical credential might consist of: Information related to identifying the subject of the credential (for example, a photo, name, or identification number), Information related to the issuing authority (for example, a city government, national agency, or certification body), Information related to the type of credential this is (for example, a Dutch passport, an American driving license, or a health insurance card), Information related to specific attributes or properties being asserted by the issuing authority about the subject (for example, nationality, the classes of vehicle entitled to drive, or date of birth), Evidence related to how the credential was derived, and/or Information related to constraints on the credential (for example, expiration date, or terms of use).

A verifiable credential can represent all the same information that a physical credential represents. The addition of technologies, such as digital signatures, makes verifiable credentials more tamper-evident and more trustworthy than their physical counterparts. Holders of verifiable credentials can generate verifiable presentations and then share these verifiable presentations with verifiers to prove they possess verifiable credentials with certain characteristics. Both verifiable credentials and verifiable presentations can be transmitted rapidly, making them more convenient than their physical counterparts when trying to establish trust at a distance. Throughout this specification, the terms “Verifiable Credential” and data element shall be used interchangeably.

The word “verifiable” in the terms verifiable credential and verifiable presentation refers to the characteristic of a credential or presentation as being able to be verified by a verifier. For the purposes of this specification, a verifier may be either the Business or an outside third party that the Business depend on to validate the verifiable credential presented by the End-User. Verifiability of a credential does not imply that the truth of claims encoded therein can be evaluated; however, the issuer can include values in the evidence property to help the verifier apply their business logic to determine whether the claims have sufficient veracity for their needs.

Due to the sensitive nature of End-user(s) personal data, particularly with data pertaining to finances, healthcare or similar topics, data security is a top priority. The design of the system 100 is able to host multiple computing platform(s) 102, each hosting one or more Businesses, optionally on a shared computing environment or virtual machine, or within isolated computing environments (entailing segregation of networking, physical computing resources, geographical isolation, etc.), where each computing platform(s) 102 provides for the receipt of Verified Credential(s) to/from the End-User(s) according to Business-specified requirements. The system 100 then uses the content of the Verified Credential(s) as the basis for determining the content of an information request to a remote platform(s) 104.

The management of each computing platform(s) 102 is determined by a central Administration Service responsible for spawning the infrastructure required to host a specific computing platform(s) 102 within the system 100. This may be a shared computing platform(s) 102 responsible for managing the resources of multiple Business(es), or a dedicated computing platform(s) 102 responsible for managing the resource of one Business. The resources created by this computing platform(s) 102 include but are not limited to, a “virtual private cloud”, dedicated networking including subnet and DNS infrastructure, dedicated cloud computing instances or hardware, automatic provisioning of containerized application orchestration software (e.g., Kubernetes, Docker Swarm, Rancher, Nomad, etc.), provisioning of dedicated databases per internal instance, and loading of software code specific to the computing platform(s) 102 onto the containerized application orchestration software.

As stated previously, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platform(s) 104 via computing platform(s) 102 and/or according to a client/server architecture, a peer-to-peer architecture, and/or other architectures. Users may also access system 100 via remote platform(s) 104.

Computing platform(s) 102 may be configured by machine-readable instructions 106. Machine-readable instructions 106 may include one or more instruction modules. The instruction modules may include computer program modules. The instruction modules may include one or more of requirement creation module 110, a data element submission module 112, a data element validation module 114, an information request module 116, data element output module 118, and/or other instruction modules.

Requirement creation module 110 allows a given Business to create the requirements used to validate the data elements submitted by the End-User(s). An implementation of the system 100 may provide the ability for Business(es) to configure a set of requirements to be imposed on the data element(s) presented by the End-User(s). These requirements may be grouped into a single Step, which defines a discrete set of criteria for the purpose of analyzing the End-User(s) submissions into the system 100. The Business(es), in configuring their initial Step(s), may use the interface of the system 100 to formally describe specific requirements about the verifiable credentials, the requirements for those Verifiable Credential(s), and the trusted data used by the Business(es) in order to validate the End-User(s) submissions. This includes describing specific requirements about the data elements in isolation, as well as describing that the data in between the requirements must correlate in specific ways, such as a field within each having an identical, or similar, value. A criteria to be tested, for example, may be “if a value at the data path ‘credentialSubject.data.creditScore.value’, in the context of the ‘creditScore’ VC in the first step of the user's application, is found to exist and have a value greater than 750”.

Data element submission module 112 allows the End-User(s) to submit the data elements they wish to have validated and accepted by the Business. The submissions by the End-user(s) may be in the form of Verifiable Credentials (either from the system 100 or from an outside trusted third party) or in the form of unverified data not yet submitted into the system 100.

Data element validation module 114 validates the submitted data elements submitted by the End-User(s) in accordance with the requirements configured by the Businesses within the system 100. The system 100 ensures that the End-User(s) submissions meet the configured requirements in order to have the system validate those submissions and make the requisite information request. For example, a Business may require that an End-User(s) submission for verifying their identity have certain completed fields (e.g., First Name, Last Name, Birthdate, etc.). These field requirements are established thru the Requirement creation module 110 by a Business. The data element validation module 114 will grab an End-User's submission (whether in the form of a verifiable credential, unverified data, or some other acceptable data type) and validate it to ensure that the format requirements are correct.

Information request module 116 makes the information request to the remote platform(s) 104 in order to enact the necessary decisioning required by the Business within the system 100. The criteria tested above in paragraph 0027 regarding the credit score may form the basis for the information request sent to the remote platform(s) 104. The request can change depending on the type of remote platform(s) 104 involved, whether a smart contract on a decentralized ledger network 200 or a trusted database on a traditional remote server.

Data element output module 118 outputs the necessary data element(s) in response to the information request made to the remote platform(s) 104. This module ensures that the outputs made from the information request to the remote platform(s) 104 are in the correct format and direct to toward the correct target (whether the target is a particular user or element of the system 100) as defined by the Business(es). This may include, but is not limited to, HTTP webhooks, FTP/SFTP servers, cloud storage buckets such as Amazon S3, smart contracts on a blockchain such as Ethereum, or VCs to be provided to the user. In the latter case, such VCs could be fed back into the system 100 as a second, third, subsequent data element for continued processing by the system 100 to provide a customer-held verification, further allowing multiple Steps within the system 100 to be made interdependent. Interfaces for appropriate configuration of each of these outputs may be provided—specific connection information, or for the instance of smart contract or other application interfaces, sufficient information needed to reproduce the data format required by the interface in question, such as blockchain network names & identifiers, URIs, function names, function parameters, etc.

In some implementations, computing platform(s) 102, remote platform(s) 104, and/or external resources 134 may be operatively linked via one or more electronic or other communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 134 may be operatively linked via some other communication mode or media.

A given remote platform 104 may include one or more processors configured to execute computer program modules. The computer program modules may be configured to enable an expert or user associated with the given remote platform 104 to interface with the system 100 and/or external resources 134, and/or provide other functionality attributed herein to remote platform(s) 104. By way of non-limiting example, a given remote platform 104 and/or a given computing platform 102 may include one or more of decentralized ledger network 200, a server, a desktop computer, a laptop computer, a handheld computer, a tablet computing platform, a Netbook, a Smartphone, a gaming console, and/or other computing platforms.

External resources 134 may include sources of information outside of system 100, external entities participating with system 100, and/or other resources. In some implementations, some or all of the functionality attributed herein to external resources 134 may be provided by resources included in system 100.

Computing platform(s) 102 may include electronic storage 136, one or more processors 138, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 136 may comprise non-transitory storage media that electronically stores information. The electronic storage media of electronic storage 136 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 136 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 136 may include one or more virtual storage resources (e.g., cloud storage, a virtual private network, and/or other virtual storage resources). Electronic storage 136 may store software algorithms, information determined by processor(s) 138, information received from computing platform(s) 102, information received from remote platform(s) 104, and/or other information that enables computing platform(s) 102 to function as described herein.

Processor(s) 138 may be configured to provide information processing capabilities in computing platform(s) 102. As such, processor(s) 138 may include one or more of a digital processor, an analog processor, a digital circuit designed to process information, an analog circuit designed to process information, a state machine, and/or other mechanisms for electronically processing information. Although processor(s) 138 is shown in FIG. 1 as a single entity, this is for illustrative purposes only. In some implementations, processor(s) 138 may include a plurality of processing units. These processing units may be physically located within the same device, or processor(s) 138 may represent processing functionality of a plurality of devices operating in coordination. Processor(s) 138 may be configured to execute modules 108, 110, 112, 114, 116, and/or 118, and/or other modules. Processor(s) 138 may be configured to execute modules 108, 110, 112, 114, 116, and/or 118, and/or other modules by software; hardware; firmware; some combination of software, hardware, and/or firmware; and/or other mechanisms for configuring processing capabilities on processor(s) 138. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, and/or 118 are illustrated in FIG. 1 as being implemented within a single processing unit, in implementations in which processor(s) 138 includes multiple processing units, one or more of modules 108, 110, 112, 114, 116, and/or 118 may be implemented remotely from one or more of the other modules. The description of the functionality provided by the different modules 108, 110, 112, 114, 116, and/or 118 described below is for illustrative purposes, and is not intended to be limiting, as any of modules 108, 110, 112, 114, 116, and/or 118 may provide more or less functionality than is described. For example, one or more of modules 108, 110, 112, 114, 116, and/or 118 may be eliminated, and some or all of its functionality may be provided by other ones of modules 108, 110, 112, 114, 116, and/or 118. As another example, processor(s) 138 may be configured to execute one or more additional modules that may perform some or all of the functionality attributed below to one of modules 108, 110, 112, 114, 116, and/or 118.

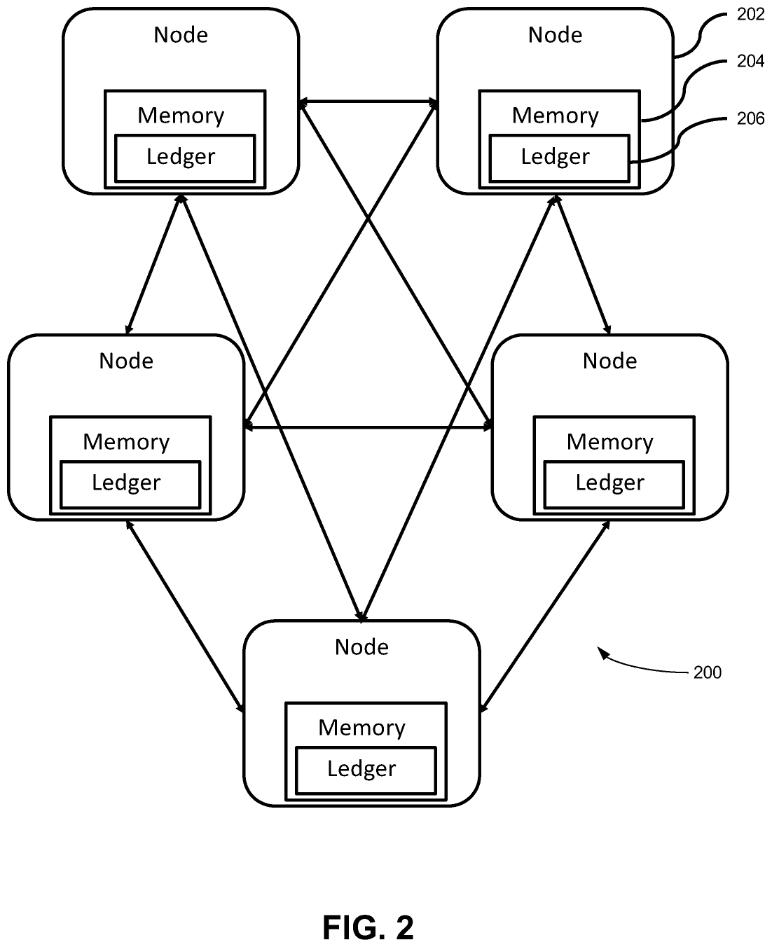

FIG. 2 illustrates an exemplary diagram of a remote platform(s) 104 as a decentralized ledger network found within the system 100, in accordance with one or more implementations. The remote platform(s) 104 may include a plurality of nodes 202, each node 202 in communication with at least one other node 202 within the network. Node(s) 202 may include computing platform(s) 102 but can also include any device capable of storing information and communicating over the remote platform(s) 104.

Each node 202 may further include a memory 204 that further stores all or a portion of a public ledger 206. The public ledger 206 may be utilized to store all or a portion of the instructions 106 tied to the system 100. By way of example, the public ledger 206 may be used to store a blockchain smart contract utilized within system 100 and method 300. The memory may consist of data storage 136 and may comprise non-transitory storage media that electronically stores information as discussed within this disclosure. By way of example, the remote platform(s) 104 may be a network tied to any public or private blockchain network or networks in connection with any of a plurality of cryptocurrencies described within this disclosure.

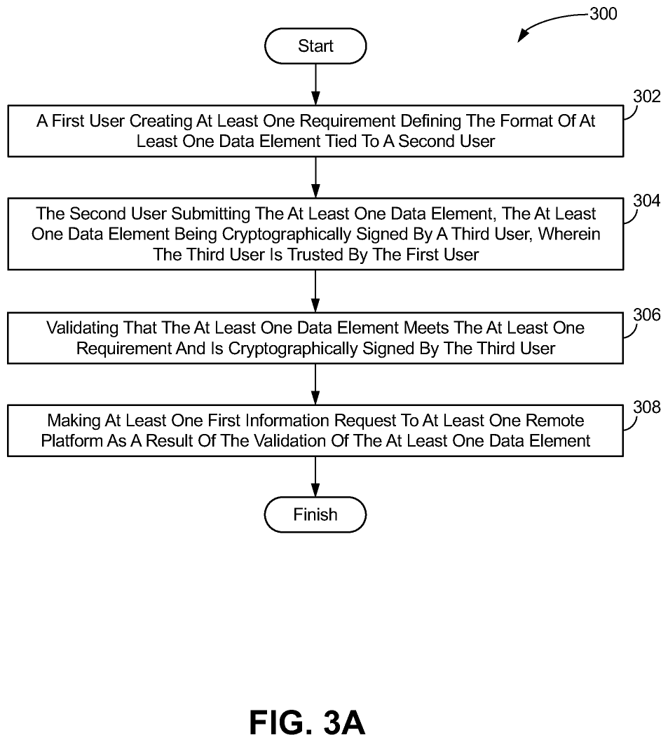

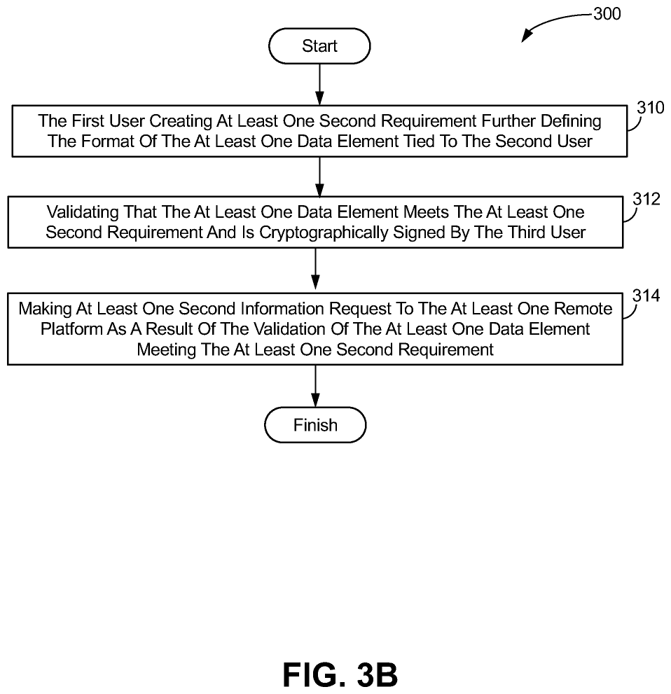

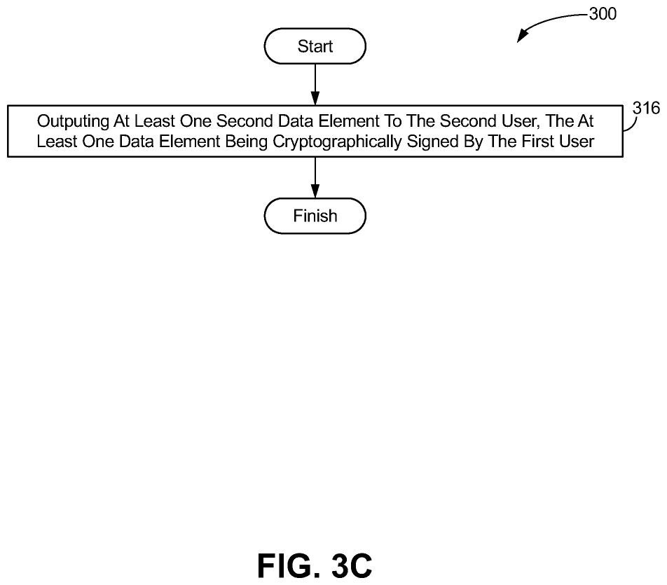

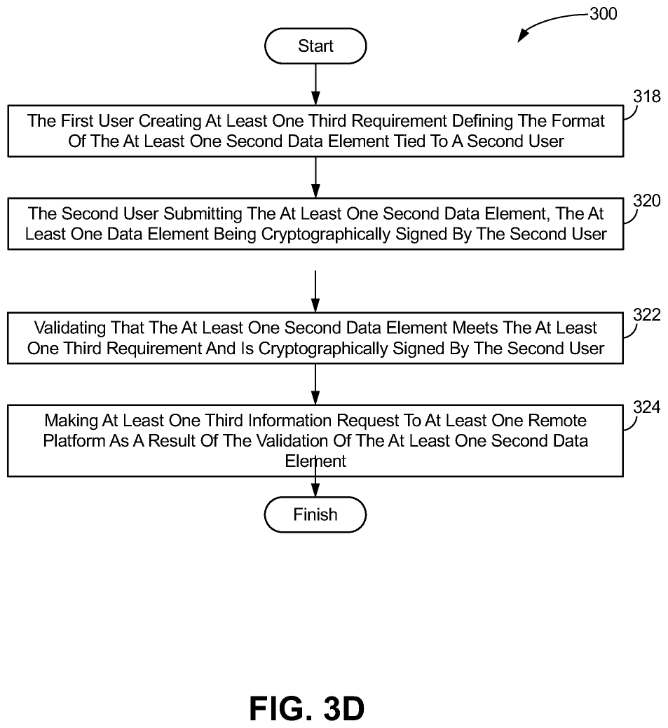

FIGS. 3A, 3B, 3C, and/or 3D illustrates a method 300 for validating cryptographically signed information, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIGS. 3A, 3B, 3C, and/or 3D and described below is not intended to be limiting.

In some implementations, method 300 may be implemented in one or more processor(s) 138. The one or more processor(s) 138 may include one or more devices executing some or all of the operations of method 300 in response to instructions stored electronically on an electronic storage 136. The one or more processor(s) 138 may include one or more devices configured through hardware, firmware, and/or software to be specifically designed for execution of one or more of the operations of method 300.

FIG. 3A illustrates method 300, in accordance with one or more implementations.

An operation 302 may include a first user creating at least one requirement defining the format of at least one data element tied to a second user. By way of the example, a Business(es) may use the requirement creation module 110 in order to configure the verifiable credential requirements for an End-User. Operation 316 may also happen simultaneously with operation 302 through the data element output module 118. This simultaneously operation allows a Business to configure both the Verifiable Credential requirements and the possible outputs of the system 100 at the completion of a Step (as defined above). This operation may include the addition of End-Users to the system 100 in order to submit data elements, verifiable credentials, etc. Furthermore, a Business may also be able to add these requirements and allow End-Users to submit data elements themselves without any prior authorization. This “self-enrollment” will grant End-User additional privacy when submitting a given data element as they not required to engage with Business in order to engage with the system 100. Operation 302 may be performed by one or more processor(s) 138 configured by machine-readable instructions 106 including a module that is the same as or similar to requirement creation module 110, in accordance with one or more implementations.

An operation 304 may include the second user submitting the at least one data element, the at least one data element being cryptographically signed by a third user, wherein the third user is trusted by the first user. The End-User, once directed by the Business to submit a Verifiable Credential or other data elements, may request the requirements for the given data element, which are presented by the system 100. With the requirements in hand, an End-User may submit the required data element to the system 100. In the case of data elements as Verifiable Credential(s), End-User(s) may receive the Verifiable Credential(s) cryptographically encoded by a third party trusted by the Business(es). In some implementations of the system 100 the trusted third party and the Business can constitute the same entity. Operation 304 may be performed by one or more processor(s) 138 configured by machine-readable instructions 106 including a module that is the same as or similar to data element submission module 112, in accordance with one or more implementations.

An operation 306 may include validating that the at least one data element meets the at least one requirement and is cryptographically signed by the third user. Such validation may occur sequentially, recursively, or both depending on the requirements configured by the Business at operation 302. Success or failure of this validation may also trigger further sequential requirements depending on the configuration of the requirements by the Business. Operation 306 may be performed by one or more processor(s) 138 configured by machine-readable instructions 106 including a module that is the same as or similar to data element validation module 114, in accordance with one or more implementations.

An operation 308 may include making at least one first information request to at least one remote platform as a result of the validation of the at least one data element. As with operation 306 above, such information requests may occur sequentially, recursively, or both depending on the requirements configured by the Business at operation 302. Operation 308 may be performed by one or more processor(s) 138 configured by machine-readable instructions 106 including a module that is the same as or similar to information request module 116, in accordance with one or more implementations. All four prior operations constitute Steps as defined within this specification and may repeat as dictated configurations of requirements by the Business(es).

FIG. 3B further illustrates method 300, in accordance with one or more implementations.

An operation 310 may include the first user creating at least one second requirement further defining the format of the at least one data element tied to the second user. Operation 310 may be performed by one or more processor(s) 138 configured by machine-readable instructions 106 including a module that is the same as or similar to requirement creation module 110, in accordance with one or more implementations.

An operation 312 may include validating that the at least one data element meets the at least one second requirement and is cryptographically signed by the third user. A particular business use-case of this operation is when a Business wishes to establish tiered-access to resources or information. The system 100 may include this step to continue validation required VCs tied to an End-User(s) and can provide the necessary access or VCs accordingly. As such the system 100 utilizes the same underline data elements and logic to scale up and provide increasingly more complex and secured access and/or information. Operation 312 may be performed by one or more processor(s) 138 configured by machine-readable instructions 106 including a module that is the same as or similar to data element validation module 114, in accordance with one or more implementations.

An operation 314 may include making at least one second information request to the at least one remote platform as a result of the validation of the at least one data element meeting the at least one second requirement. Operation 314 may be performed by one or more processor(s) 138 configured by machine-readable instructions 106 including a module that is the same as or similar to information request module 116, in accordance with one or more implementations. All three of the operations above (310, 312, and 314) indicate the example of an initial step triggering additional steps within the system 100. Such additional Steps may be finite in number or may continue until a set requirement is validated and/or met by an End-user within the system 100.

FIG. 3C further illustrates method 300, in accordance with one or more implementations.

An operation 316 may include outputting at least one second data element to the second user, the at least one data element being cryptographically signed by the first user. Such outputs may occur in the form of calls to a decentralized ledger network 200 but may also include dedicated cloud storage of resulting VCs, transmission resulting VCs back to the End-User, or transmission of VCs to alternate points within or outside of the system 100. Such transmission may occur any number of technologies, such as through the use of webhooks. Operation 316 may be performed by one or more processor(s) 138 configured by machine-readable instructions 106 including a module that is the same as or similar to data element output module 118, in accordance with one or more implementations.

FIG. 3D further illustrates method 300, in accordance with one or more implementations.

An operation 318 may include the first user creating a least one third requirement defining the format of the at least one second data element tied to the second user. Operation 318 may be performed by one or more processor(s) 138 configured by machine-readable instructions 106 including a module that is the same as or similar to requirement creation module 110, in accordance with one or more implementations.

An operation 320 may include the second user submitting the at least one second data element, the at least one data element being cryptographically signed by the second user. This operation allows for the fusion of initial credentials to generate a more complex credential. A simple example may involve an End-User submitting a couple of validated credentials tied to name, birthdate, and residency to generate a more complex identification-type Validated Credential. Operation 320 may be performed by one or more processor(s) 138 configured by machine-readable instructions 106 including a module that is the same as or similar to data element submission module 112, in accordance with one or more implementations.

An operation 322 may include validating that the at least one second data element meets the at least one third requirement and is cryptographically signed by the second user. Operation 322 may be performed by one or more processor(s) 138 configured by machine-readable instructions 106 including a module that is the same as or similar to data element validation module 114, in accordance with one or more implementations.

An operation 324 may include make at least one third information request to at least one remote platform as a result of the validation of the at least one second data element. Operation 324 may be performed by one or more processor(s) 138 configured by machine-readable instructions 106 including a module that is the same as or similar to information request module 116, in accordance with one or more implementations.

In any of the various examples of Steps as presented above, arbitrary intervention against the End-User's submitted data elements may occur as a result of the requirements presented by the Business. Optionally, additional permitted behavior may be allowed by the system 100, such as allowing the End-User to submit additional information or receive additional data elements as a result of the successful completion of the required Steps previously presented.

In some implementations of the system 100, the two steps requiring, respectively, the first information request and the second information request, occur sequentially. Any number of steps may further be configured in sequence. The execution of steps may occur upon success, failure, or both, of the previous step. The execution of actions configured for a specific Step may occur upon success, failure, or both, of the requirements within that step. Different properties arise from different possible ways of ordering steps and considering what data will be available according to such orderings. As such first, second, third, and subsequent requirements and data elements may result from the scalable and interdependent chaining of Steps as per the configurations dictated by the Business.

In some implementations, Steps can only be defined as a directed acyclic graph and may not converge after they've diverged. This directed acyclic property can ensure that any data that was required at a step prior or equal to the current step at which processing is occurring will be available provided the submission requirements for that Step have been met. This guarantee can be leveraged to provide the Business with a user interface that allows them to map data inputs that were made available at prior Steps, as part of the configuration for a submission by an End-User, into the data format that may be required for an Output, should the Output have a strictly defined data schema (as is the case, for instance, for outputting data into a smart contract, which requires exact data types to be provided for the parameters of the functions provided on the smart contract). In some implementations of the system, the first information request and the second information request may be further defined as a directed acyclic graph. In some implementations of the system, each step is conditionally dependent on at least one prior step. In some implementations of the system, upon a request of the first user, the first information request is made without the validation that the at least one data element meets the at least one requirement.

It is further possible to provide application programmable interfaces (APIs) that allow control of the sequence of events within system 100 by an external resource 134. These may arbitrarily alter the state of the Business's configuration of requirements for the data elements within the system 100. The most likely relevant uses of such API endpoint functionality are to allow the Business to configure requirements such that they reflect some subset of a data format used to represent individual or business entities within their own systems, and further populate additional requirements within the system 100 created against those prior Steps with that data, so that they can provide further verification records for the entities described by the external resources 134. Since the state of applications can also be controlled by the Business via these APIs, the Business can further read and write the state of applications in regard to specific Steps using any arbitrary business logic of their choosing.

As will be appreciated by one skilled in the art, aspects of the present invention may be embodied as a system, method, or computer program(s). Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program(s) embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium or data store may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: portable computer diskette, hard disk, read only memory (ROM), optically readable storage media (e.g., CD-ROM, DVD), magnetically readable storage media (e.g., magnetic tape, magnetic hard drive, floppy drive), electrical charge-based storage media or random access memory (e.g., EEPROM, RAM), solid-state storage media (e.g., flash drive, solid-state hard drive), other electronically readable storage media and/or any suitable combination of the foregoing. In the context of this disclosure, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, and/or any suitable combination of the foregoing.

Computer program code for carrying out operations for aspects of the present invention may be written in any combination of one or more programming languages, including: object oriented programming languages such as Java, Smalltalk, C++, conventional procedural programming languages such as the “C” programming language or similar programming languages, scripting language such as Perl, JavaScript/Typescript, and/or VBS, functional languages such as Lisp and/or ML, logic-oriented languages such as Prolog, and/or blockchain smart contract languages such as Solidity, Move, Tezos, fi, and/or Plutus. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a virtual private network (VPN), and/or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program(s) according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus or device provide processes for implementing the functions/acts specified in the flowchart and/or block diagram block or blocks.

The flowchart and block diagrams in the figures illustrate the architecture, functionality, and operation of possible implementations of the system(s), method(s), and computer program(s) according to various embodiments of the present invention. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program(s) may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instruction embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively or may include one or more stand-alone components. The hardware and software components of the computer system of the present disclosure may include and may be included within fixed and portable devices such as desktops, laptops, and/or servers. A module may be a component of a device, software, program, or system that implements some “functionality,” which can be embodied as software, hardware, firmware, and/or electronic circuitry.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

Furthermore, although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for validating cryptographically signed information, the system comprising:
one or more hardware processors configured by machine-readable instructions to:
allow a first user to create at least one requirement defining the format of at least one data element tied to a second user;
allow the second user to submit the at least one data element, the at least one data element being cryptographically signed by a third user, wherein the third user is trusted by the first user;
validate that the at least one data element meets the at least one requirement and is cryptographically signed by the third user; and
make at least one first information request to at least one remote platform as a result of the validation of the at least one data element.

2. The system of claim 1, wherein the one or more hardware processors are further configured by machine-readable instructions to:
allow the first user to create at least one second requirement further defining the format of the at least one data element tied to the second user;
validate that the at least one data element meets the at least one second requirement and is cryptographically signed by the third user; and
make at least one second information request to the at least one remote platform as a result of the validation of the at least one data element meeting the at least one second requirement.

3. The system of claim 1, wherein the one or more hardware processors are further configured by machine-readable instructions to output at least one second data element to the second user, the at least one data element being cryptographically signed by the first user.

4. The system of claim 2, wherein the one or more hardware processors are further configured by machine-readable instructions to:
allow the first user to create a least one third requirement defining the format of the at least one second data element tied to the second user;
allow the second user to submit the at least one second data element, the at least one data element being cryptographically signed by the second user;
validate that the at least one second data element meets the at least one third requirement and is cryptographically signed by the second user; and
make at least one third information request to at least one remote platform as a result of the validation of the at least one second data element.

5. The system of claim 2, wherein the first information request and the second information request occur sequentially.

6. The system of claim 5, wherein the first information request and the second information request may be further defined as a directed acyclic graph.

7. The system of claim 2, wherein each step is conditionally dependent on at least one prior step.

8. The system of claim 5, wherein upon a request of the first user, the first information request is made without the validation that the at least one data element meets the at least one requirement.

9. A method for validating cryptographically signed information, the method comprising:
a first user creating at least one requirement defining the format of at least one data element tied to a second user;
the second user submitting the at least one data element, the at least one data element being cryptographically signed by a third user, wherein the third user is trusted by the first user;
validating that the at least one data element meets the at least one requirement and is cryptographically signed by the third user; and
making at least one first information request to at least one remote platform as a result of the validation of the at least one data element.

10. The method of claim 9, further comprising:
the first user creating at least one second requirement defining the format of the at least one data element tied to the second user;
validating that the at least one data element meets the at least one second requirement and is cryptographically signed by the third user; and
making at least one second information request to the at least one remote platform as a result of the validation of the at least one data element meeting the at least one second requirement.

11. The method of claim 9, further comprising outputting at least one second data element to the second user, the at least one data element being cryptographically signed by the first user.

12. The method of claim 10, further comprising:
the first user creating a least one third requirement defining the format of the at least one second data element tied to the second user;
the second user submitting the at least one second data element, the at least one data element being cryptographically signed by the second user;
validating that the at least one second data element meets the at least one third requirement and is cryptographically signed by the second user; and
making at least one third information request to at least one remote platform as a result of the validation of the at least one second data element.

13. The method of claim 10, wherein the first information request and the second information request occur sequentially.

14. The method of claim 13, wherein the first information request and the second information request may be further defined as a directed acyclic graph.

15. The method of claim 10, wherein each step is conditionally dependent on at least one prior step.

16. The method of claim 13, wherein upon a request of the first user, the first information request is made without the validation that the at least one data element meets the at least one requirement.

17. A non-transient computer-readable storage medium having instructions embodied thereon, the instructions being executable by one or more processors to perform a method for validating cryptographically signed information, the method comprising:
a first user creating at least one requirement defining the format of at least one data element tied to a second user;
the second user submitting the at least one data element, the at least one data element being cryptographically signed by a third user, wherein the third user is trusted by the first user;
validating that the at least one data element meets the at least one requirement and is cryptographically signed by the third user; and
making at least one first information request to at least one remote platform as a result of the validation of the at least one data element.
